(19) United States
(12) Patent Application Publication
(10) Pub. No.: US 2010/0095649 A1
(43) Pub. Date: Apr. 22, 2010

(54) STAGED COMBUSTION SYSTEMS AND METHODS

(75) Inventors: John Dewey Blouch, Glenville, NY (US); Ertan Yilmaz, Albany, NY (US); Balachandar Varatharajan, Loveland, OH (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/254,395

(22) Filed: Oct. 20, 2008

(51) Int. Cl. F02C 3/20; F02C 7/22

(52) U.S. Cl. 60/39.463; 60/780

(57) ABSTRACT

Systems and methods for staged combustion are provided. One staged combustion system includes a first fuel source for supplying a first fuel having a first chemical composition, a first injector for injecting the first fuel, a second fuel source for supplying a second fuel having a second chemical composition such that a relative reactive concentration of one or more of hydrogen, carbon monoxide, a hydrocarbon, or a combination of two or more hydrocarbons, in the first chemical composition is different from that of the second chemical composition, and a second injector situated for injecting the second fuel downstream of the first injector.

### STATEMENT OF FEDERALLY FUNDED RESEARCH

This invention was made with Government support under contract number DE-FC26-05NT42643 awarded by the Department of Energy. The Government has certain rights in the invention.

### BACKGROUND

Embodiments of the invention relate to staged combustion systems and methods.

Various types of gas turbine systems exist. For example, aeroderivative gas turbines are employed for applications such as power generation, marine propulsion, gas compression, cogeneration, and offshore platform power. A gas turbine system generally includes a compressor for compressing an sir flow, a combustor that combines compressed air with fuel and ignites the mixture to generate a working gas, and a turbine section for expanding the working gas and generating power. The combustor is generally arranged coaxially with the compressor and the turbine section.

It is advantageous for the combustors of the gas turbine systems to minimize emissions such as nitrogen oxides (NOₓ), carbon monoxide, and unburned hydrocarbons. Axial staging is one approach for reducing such emissions.

Even with axial staging, NOₓ is produced in higher amounts at higher flame temperatures. NOₓ emissions can be reduced by lowering the flame temperature and/or lowering the residence time of the fuel in high temperature zones. Carbon monoxide is created as an intermediate between the fuel and carbon dioxide. As compared with NOₓ emissions, a longer residence time and higher temperature favors low carbon monoxide emissions. An initial flame zone (or first stage) of a staged combustor typically has a low flame temperature and a long residence time to balance NOₓ and carbon monoxide requirements. A second flame zone is used to bring the combustion products to the desired final temperature while minimizing the residence time at this temperature. Typically, the second stage injector is situated in a zone of higher temperature than the first stage injector. Thus the second stage injector is more prone to heat damage. Occasionally, air, steam, nitrogen, or another inert gas may be may be mixed with the fuel or co-injected in the second stage to improve thermal management and provide cooling.

Axial staging is also used to address another combustor problem known as combustion dynamics or acoustics. Combustion dynamics result from an interaction between the heat released from combustion and the pressure waves occurring in the combustor or fuel lines. In axial staging, the issue of combustion dynamics is addressed by spreading the combustion over the two zones to decouple or weaken the interaction.

Combustion characteristics of the fuel often limit design options in axially staged combustors. For example, slow reaction rates can result in incomplete combustion and the emission of carbon monoxide and unburned hydrocarbons. On the other hand, reaction rates that are too high can lead to flameholding where the second stage reaction zone is located so close to the seconds stage injector that it can sustain damage. Finally, poor mixing between the second stage fuel and primary stage products can exacerbate both of the problems mentioned above in addition to causing hot flame zones that produce higher NOx, poorly stabilized flames, and other problems. Typically, one or more diluents or air may be added to the fuel or injected near the fuel in the staged combustor to increase the momentum of the injected fuel to enhance mixing processes.

Typically, the axial staged combustor operates by transfer of heat energy from a leaner-burning stage or the first stage to a richer-burning stage or the second stage in order to accelerate a partial oxidation reaction. Heat exchange between the stages is used to accelerate the partial oxidation reaction occurring in the stage having the higher of the two equivalence ratios. The heat exchange may be facilitated by one or more of a direct mixing of the combustion gases of the two stages, or a mechanism for the transfer of heat energy without the actual mixing of the gas products, or by introducing steam into one or both of the stages.

### BRIEF DESCRIPTION

It would be desirable to have more flexibility in design of axially staged combustion systems and to reduce undesired emissions in such combustion systems.

Briefly, in accordance with one embodiment disclosed herein, a staged combustion system includes a first fuel source for supplying a first fuel having a first chemical composition, a first injector for injecting the first fuel, a second fuel source for supplying a second fuel having a second chemical composition, where a relative reactive concentration of one or more of hydrogen, carbon monoxide, a hydrocarbon, or a combination of two or more hydrocarbons, in the first chemical composition is different from that of the second chemical composition, and a second injector situated for injecting the second fuel downstream of the first injector.

In another embodiment, a staged combustor configured to separately introduce two or more fuels with varying chemical compositions at two or more stages of the combustor is provided, where a relative concentration of one or more hydrogen, carbon monoxide, a hydrocarbon, or a combination of two or more hydrocarbons, in the first chemical composition is different from that of the second chemical composition.

In another embodiment, a method for staged combustion is provided. The method includes at a first stage, introducing a first fuel; and then at a second stage, introducing a second fuel having a different chemical composition than the first fuel, where a relative reactive concentration of one or more of hydrogen, carbon monoxide, a hydrocarbon, or a combination of two or more hydrocarbons, in the first chemical composition is different from that of the second chemical composition.

In another embodiment, a method for staged combustion is provided. The method includes introducing an initial fuel to a separator for chemically separating the initial fuel to form a first fuel and a second fuel, wherein the first fuel is less reactive than the second fuel, introducing the first fuel at a first stage; and then introducing the second fuel at a second stage.

In another embodiment, a method for staged combustion is provided. The method includes dividing a first fuel into a first portion and a second portion; introducing the first portion of the first fuel at a first stage; mixing the second portion of the first fuel with an additional fuel to form a second fuel, where the first fuel is less reactive than the second fuel; and then introducing the second fuel at a second stage.

### DRAWINGS

These and other features, aspects, and advantages of the present invention will become better understood when the following detailed description is read with reference to the accompanying drawings in which like characters represent like parts throughout the drawings, wherein:

FIG. 1 is a cross-sectional view of a combustor engine.

FIGS. 2-5 are block diagrams of exemplary staged combustion system embodiments that are disclosed herein.

FIG. 6 is a cross-sectional side view of a combustor for a combustor section employed in a turbine containing system.

### DETAILED DESCRIPTION

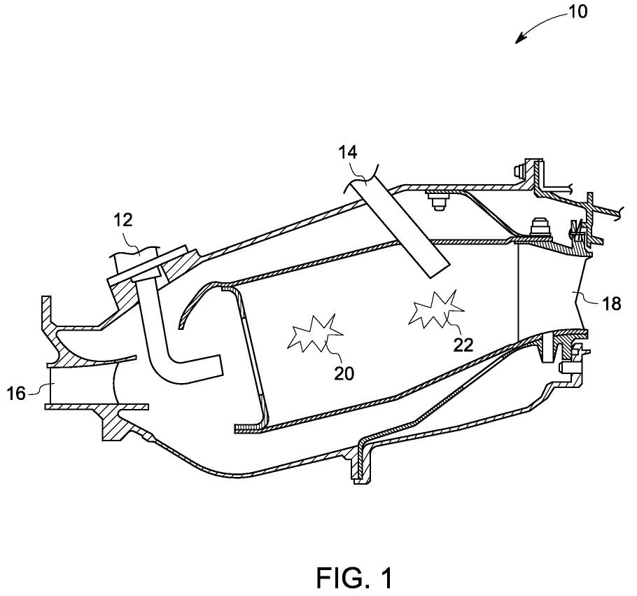

In one embodiment, as shown in FIG. 1, a staged combustion system 10 comprises: a first fuel source for supplying a first fuel having a first chemical composition, a second fuel source for supplying a second fuel having a second chemical composition, such that a relative reactive concentration of one or more of hydrogen, carbon monoxide, a hydrocarbon, or a combination of two or more hydrocarbons n, in the first chemical composition is different from that of the second chemical composition. As used herein a different “relative reactive concentration” means a different concentration among the reactive components (hydrogen, carbon monoxide, a hydrocarbon, or a combination of two or more hydrocarbons), regardless of whether one or both of the fuels may have one or more non-reactive components such as nitrogen, carbon dioxide, and steam. In other words, if non-reactive components were to be removed from the first and second fuels, the resulting chemical compositions would still be different. Also, as used herein, singular forms such as “a,” “an,” and “the” include plural referents unless the context clearly dictates otherwise. For example, although a single injector is shown for injecting fuel from each respective fuel source, in some embodiments, multiple injectors may be used to inject the first and/or second fuels.

In certain embodiments, the second fuel may include a more reactive fuel than the first fuel. In some of these embodiments, the first fuel is a lower energy content fuel than the second fuel. In the other embodiments, the first fuel is a higher energy content fuel than the second fuel. In the presently contemplated embodiment, a first injector 12 is present for injecting the first fuel, and a second injector 14 is present for injecting the second fuel, where the second injector 14 is situated downstream of the first injector 12. The first injector 12 may be located in a first stage of the staged combustion system 10. Similarly, the second injector 14 may be located in a first stage of the staged combustion system 10. Typically, the upstream end of the second stager is interconnected with the downstream end of the first stage by a throat region of reduced cross-section. In other words, the throat region may be tapered such that the cross-section of the throat region close to the first stage is greater than the cross-section close to the second stage. The first and second stages may have a circular cross-section, although other configurations may also be employed.

In one embodiment, the first and second fuels may be both liquid fuels, or both gaseous fuels. In another embodiment, one of the first fuel or the second fuel may be a liquid fuel and the other may be a gaseous fuel. As used herein, the term “more reactive fuel” refers to a fuel that has a relatively faster reaction rate, and similarly, the term “less reactive fuel” refers to a fuel that has a relatively slower reaction rate. Further, as used herein, the term “high energy fuel” refers to a fuel that has higher energy density, and similarly, the term “low energy fuel” refers to a fuel that has lower energy density. It should be acted that a high energy fuel may or may not be more reactive than a low energy fuel.

Combustion system 10 is employed in any desired application with several examples including a gas turbine, a gas generator, a gas turbine engine, or other heat generating devices. In the illustrated example, combustion system 10 includes an entry port 16 for the air and an exit port 18. Reference numerals 20 and 22 refer to first and second stages of combustion, respectively. As compared with conventional approaches wherein the fuel being added to each stage is the same with the only difference being the additional gas such as air that may be mixed differently at different stages, injecting a more reactive fuel downstream from the fuel supplied by the first injector may be done so as to result in less pollutants, to maintain a more constant fuel-to-air ratio in the combustion zone, to reduce incidents of flashback in the primary zone. In one embodiment, one or both of the first and second fuels are pre-mixed with air prior to being supplied to the first and second injectors, respectively. In another embodiment, fuel may be injected into air in an upstream part of the combustor such that the fuel and air are allowed to mix before the flame zone. Additionally, small amounts of air may be injected in second stage for purposes such as cooling.

Fuels that are more reactive than natural gas, such as hydrogen, ethane, or other hydrocarbons, tend to have higher flame-speeds and/or faster ignition times that may result in premature combustion in parts of the combustor system that are not designed to withstand flame temperatures. As used herein, the term “natural gas” refers to a gaseous fuel including primarily (CH₄), and one or more of others such as but not limited to, ethane (C₂H₆), butane (C₄H₁₀), propane (C₃H₈), carbon dioxide (CO₂), nitrogen (N₂), helium (He₂), hydrogen sulfide (H₂S)), or combinations thereof. For fuels that are less reactive than natural gas (for example, a fuel having higher concentrations of carbon monoxide, or carbon dioxide, or nitrogen, or combinations thereof), slow flame speeds may lead to blow off such that the net flow may blow the flame downstream from its normal stabilization zone and extinguish it. If total residence time in the combustor is too low, combustion may not go to completion. In this case, unhurried fuel or excessive carbon monoxide may be present in the exhaust.

By alternating the reactive components of the fuel streams and thus varying the fuel compositions being injected at different stages, effectiveness of staged combustion may be increased. For example, some of the more reactive fuel may be introduced at the second stage of the combustor so that the second fuel will burn quickly and minimize residence time. Accordingly, the slower reacting fuel may be moved to the first zone of the combustor to allow complete combustion by increasing the residence time of the first fuel in the combustor.

In addition, inert substances, such as nitrogen and carbon dioxide may be introduced at the second stage for thermal management. For example, nitrogen may be introduced at the second stage to assist in cooling the injector.

In one embodiment, the first fuel has a higher carbon content than the second fuel. In another embodiment, the second fuel has a higher content of hydrogen than the first fuel. In a more specific example, the first fuel comprises one or more of natural gas, or carbon monoxide, or hydrogen, or nitrogen, and the second fuel comprises one or more of hydrogen, or methane, hydrocarbons larger than methane, or natural gas. It should be noted that the number of fuel sources is not necessarily limited to two. In some embodiments, the combustion system may include more than two fuel sources. Also, the staged combustion may be axially staged, or radially staged or configured in some other form.

In some embodiments, the second injector may be located in a stream of combustion products from the first stage. In one embodiment where the staged combustion system is employed in a gas turbine, the second injector may be located in a turbine inlet section or on the first stage airfoil of a turbine section. In this embodiment, the combustion system may include an intake section, a compressor section downstream from the intake section, a combustor section having the first stage that employs the first injector, a second stage employing the second injector and located downstream from the first stage for further combusting a stream of first stage combustion products, a turbine section, and an exhaust section. The injector includes a coupling; a wall defining an airfoil shape circumscribing a fuel mixture passage; and at least one exit for communication between the fuel mixture passage and the stream of primary combustion products. In other embodiments, the second injector may be located on a surface of a wall of the combustor such that the second injector is located in a stream of the combustion products from the first stage.

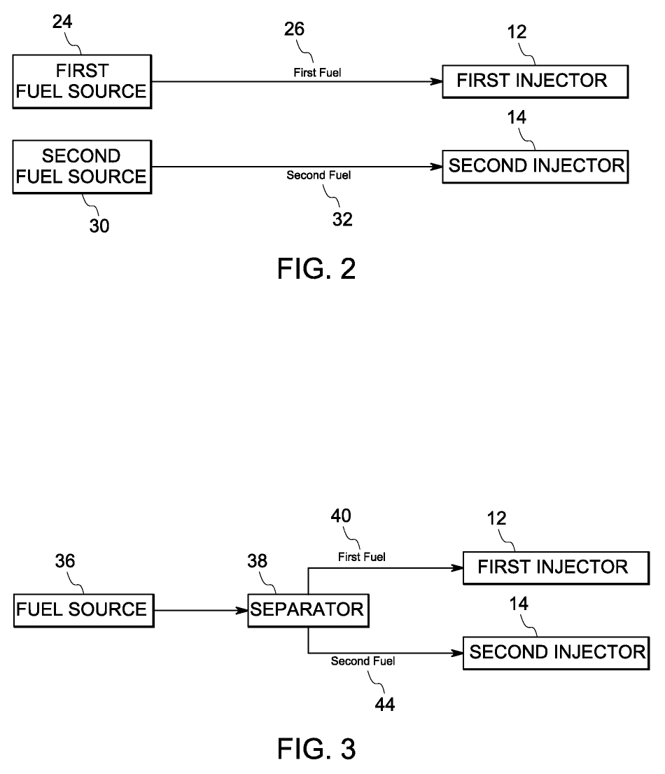

Referring now to FIG. 2, a first fuel source 24 contains a first fuel 26 to be fed into first injector 12. A second fuel source 30 contains a second fuel 32 to be fed into the combustor by the second injector 14. For example, the first fuel 26 may include natural gas, and the second fuel 32 may include about 50 percent by volume methane and about 50 percent by volume carbon monoxide. In another embodiment, the first fuel 26 includes natural gas, and the second fuel 32 includes about 50 percent by volume methane and about 50 percent by volume hydrogen.

In one embodiment, at least one of the first and second fuel sources includes a fuel separator for chemically separating an initial fuel into the first fuel, the second fuel, or both. In the embodiment of FIG. 3, for example, a fuel separator 38 is provided for chemically separating a fuel supplied by an initial fuel source 36. In the illustrated embodiment, the initial fuel contained in fuel source 36 is separated into first fuel 40 and second fuel 44. First fuel 40 is transported to first injector 12, and second fuel 44 is transported to second injector 14.

In one example where the fuel in the fuel source 36 includes about 90 percent by volume hydrogen and about 10 percent by volume carbon monoxide, the first fuel 40 includes a mixture of about 20 percent by volume carbon monoxide and 80 percent by volume hydrogen, whereas, the second fuel 44 includes about 100 percent by volume hydrogen. In this embodiment, the fuel in the fuel source 36 may be pre-treated for separating at least a portion of carbon.

In another example, the fuel in the fuel source 36 includes gas used in integrated gasification combined cycle such as “syngas”. As used herein, “syngas” may include gaseous fuel such as, but not limited to, carbon monoxide (CO), carbon dioxide (CO₂), and hydrogen (H₂) with the composition being dependent upon the feedstock material. For example, the initial fuel may nave a composition that includes about 40 percent by volume hydrogen, about 40 percent by volume carbon monoxide, and about 20 percent by volume carbon dioxide, the first fuel 40 may include a mixture of about 33.3 percent by volume hydrogen and about 66.6 percent by volume carbon monoxide, and the second fuel 44 may include about 50 percent by volume hydrogen and about 50 percent by volume carbon dioxide.

In another example where the fuel in the fuel source 36 includes about 50 percent by volume hydrogen and about 50 percent by volume carbon monoxide, the first fuel 38 includes about 100 percent by volume carbon monoxide, whereas, the second fuel 44 includes about 100 percent by volume hydrogen.

In still another example where the fuel in the fuel source 36 includes about 50 percent by volume methane and about 50 percent by volume hydrogen, the first fuel 38 includes a mixture of about 80 percent by volume methane and about 20 percent by volume hydrogen, whereas, the second fuel 44 includes about 20 percent by volume methane and about 80 percent by volume hydrogen.

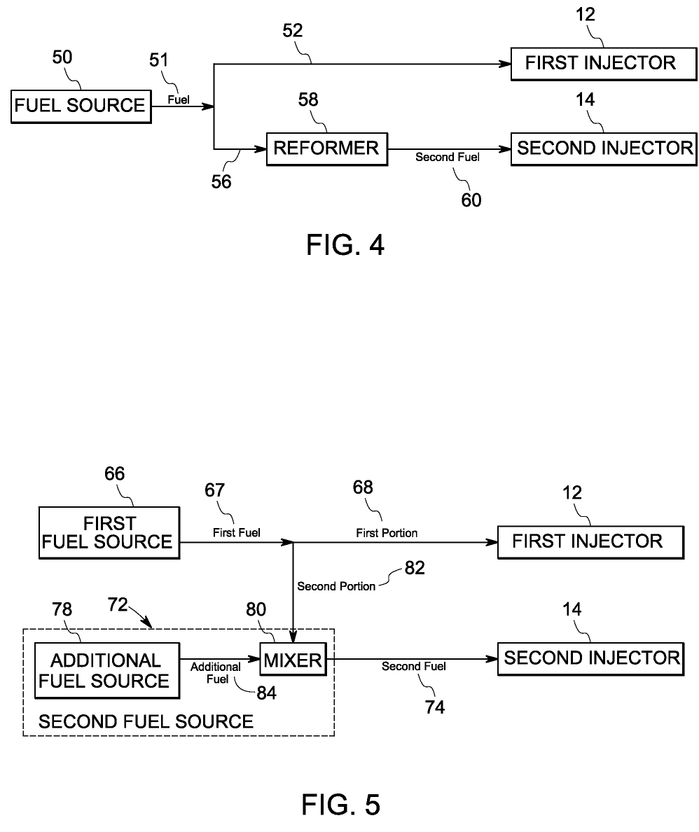

In another embodiment, at least one of the first and second fuel sources comprises a fuel reformer 58. For example, referring to FIG. 4, an initial fuel source 50 provides a fuel 51 that is portioned into two branches along fuel paths 52 and 56. The first fuel 51 is transported to first injector 12 along fuel path 52, and, along path 56, the fuel is subjected to a reformer 58 to chemically reform the fuel in order to provide the second fuel 60 to second injector 14. In one embodiment, the reformer, such as the reformer 58, may be employed to reform natural gas or other hydrocarbon fuel into a mixture of carbon monoxide and hydrogen, for example. In one example where the fuel 51 in the initial fuel source 50 includes methane, the first fuel includes methane, and the second fuel 60 includes a mixture of about 10 percent by volume carbon monoxide, 20 percent by volume hydrogen, and 70 percent by volume methane.

In another embodiment, at least one of the first and second fuel sources includes a fuel mixer to mix at least a portion of the first fuel and at least a portion of another fuel. As illustrated in FIG. 5, a first fuel source 66 contains a first fuel 67. A first portion 68 of the first fuel 67 is fed into first injector 12. A second fuel source 72 provides a second fuel 74 that is fed into second injector 14. The second fuel source 72 is a combination of an additional fuel source 78. In the illustrated embodiment, a mixer 80 mixes a portion 82 of the first fuel with the additional fuel 84 to provide a second fuel 74.

In one example wherein first fuel 67 is a natural gas and additional fuel source 78 includes a low energy content fuel, such as nitrogen, the second fuel 74 includes 50 percent by volume of the low energy content fuel (such as nitrogen) and 50 percent by volume natural gas. In another example first fuel 67 is a natural gas, the additional fuel source 78 includes a high energy content fuel, such as hydrogen, and the second fuel 74 includes 50 percent by volume of the high energy content fuel (such as hydrogen) and 50 percent by volume natural gas. In the above described embodiments, if desired, air may be mixed with either of the first or second fuels.

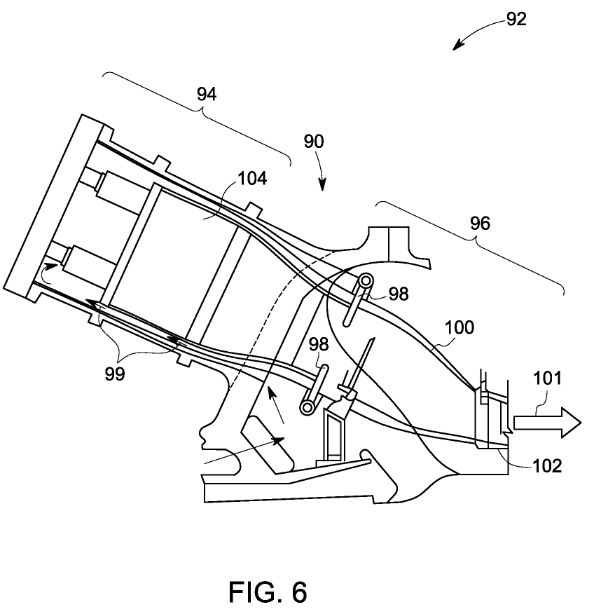

Referring now to FIG. 6, there is shown generally an axial staged combustor 90 for a turbine containing system having a combustor section 92. The turbine containing system is described in detail in U.S. Pat. No. 6,868,676, which is incorporated by reference herein in its entirety. The combustor section 92 includes a first stage 94 and a second stage 96 downstream from the first stage 92. In the illustrated embodiment, the second stage 96 includes an injector 98 for transversely injecting a second stage fuel mixture into a stream of combustion products of the first stage 94. Arrows 99 represent the direction of inflow of air and the arrow 101 represents the direction of exit of the exhaust to the turbine section. Although not illustrated, the turbine containing system may also include an intake section, a compressor section downstream of the intake section, a turbine section, and an exhaust section. The combustor section 92 may include a circular array of a plurality of circumferentially spaced combustors 90. A fuel/air mixture is burned in each combustor 90 to produce a hot energetic flow of gas, which flows through a transition piece 100 for flowing the gas to the first stage airfoil 102 of the turbine section (not shown). It is contemplated that the present technique may be used in conjunction with different combustor systems including and not limited to circular combustor systems, and annular combustor systems. In some embodiments, compressed air may be delivered to the first stage 94 of the combustor section 92 for combination and combustion with fuel mixture in a primary reaction zone 104 of each of the plurality of combustors 90. In one embodiment, injectors 98 may be provided to the turbine section such as, for example, the first stage airfoil 102 of the turbine section.

While only certain features of the invention have been illustrated and described herein, many modifications and changes will occur to those skilled in the art. It is, therefore, to be understood that the appended claims are intended to cover all such modifications and changes as fail within the true spirit of the invention.

1. A staged combustion system, comprising:
a first fuel source for supplying a first fuel having a first chemical composition;
a first injector for injecting the first fuel;
a second fuel source for supplying a second fuel having a second chemical composition such that a relative reactive concentration of one or more of hydrogen, carbon monoxide, a hydrocarbon, or a combination of two or more hydrocarbons, in the first chemical composition is different from that of the second chemical composition; and
a second injector situated for injecting the second fuel downstream of the first injector.

2. The staged combustion system of claim 1, wherein one of the first and second fuels is more reactive than the other of the first and second fuels.

3. The staged combustion system of claim 1, wherein one of the first and second fuels has a higher energy content than the other of the first and second fuels.

4. The staged combustion system of claim 1, wherein the first fuel has a higher carbon content than the second fuel.

5. The staged combustion system of claim 1, wherein the second fuel has a higher content of hydrogen than the first fuel.

6. The staged combustion system of claim 1, wherein at least one of the first and second fuel sources comprises a fuel separator for chemically separating an initial fuel into the first fuel, the second fuel, or both.

7. The staged combustion system of claim 1, wherein at least one of the first and second fuel sources comprises a fuel reformer.

8. The staged combustion system of claim 7, wherein the reformer is for reforming a hydrocarbon fuel into a mixture of carbon monoxide and hydrogen.

9. The staged combustion system of claim 1, wherein at least one of the first and second fuel sources comprises a fuel mixer.

10. The staged combustion system of claim 1, wherein the first fuel comprises one or more of a hydrocarbon, carbon monoxide, or nitrogen.

11. The staged combustion system of claim 1, wherein the second fuel comprises one or more of hydrogen, methane, hydrocarbons, or natural gas.

12. The staged combustion system of claim 1, wherein one or both of the first and second fuels are pre-mixed with air.

13. The staged combustion system of claim 1, wherein the first and second injectors are axially staged.

14. The staged combustion system of claim 1, wherein the second injector is located in a stream of combustion products from a first stage.

15. The staged combustion system of claim 14, wherein the second injector is located on a surface of a wall of a combustor.

16. The staged combustion system of claim 1, wherein the staged combustion system is employed in a gas turbine.

17. The staged combustion system of claim 16, wherein the second injector is located in a turbine inlet section or on a first stage airfoil of a turbine section.

18. A staged combustor configured to separately introduce two or more fuels with varying chemical compositions at two or more stages of the combustion such that a relative reactive concentration of one or more of hydrogen, carbon monoxide, a hydrocarbon, or a combination of two or more hydrocarbons, in the first chemical composition is different from that of the second chemical composition.

19. A method for staged combusting, comprising:
at a first stage, introducing a first fuel; and then
at a second stage, introducing a second fuel having a different relative reactive chemical composition than the first fuel such that a concentration of one or more of hydrogen, carbon monoxide, a hydrocarbon, or a combination of two or more hydrocarbons.

20. The method of claim 19, wherein one of the first and second fuels is more reactive than the other of the first and second fuels.

21. The method of claim 19, further comprising separating an initial fuel to form the first fuel and the second fuel.

22. The method of claim 19, further comprising reforming the first fuel, or the second fuel, or both.

23. The method of claim 19, further comprising mixing the first fuel or the second fuel.

24. The method of claim 19, wherein the first fuel has a longer residence time in the combustor than the second fuel.

25. The method of claim 19, further comprising interacting the fuel with a catalyst.

26. A method for staged combusting, comprising:
introducing an initial fuel to a separator for chemically separating the initial fuel to form a first fuel and a second fuel, wherein the first fuel is less reactive than the second fuel;
introducing the first fuel at a first stage; and then
introducing the second fuel at a second stage.

27. A method for staged combustion, comprising:
dividing a first fuel into a first portion and a second portion;
introducing the first portion of the first fuel at a first stage;
mixing the second portion of the first fuel with an additional fuel to form a second fuel, wherein the first fuel is less reactive than the second fuel; and then
introducing the second fuel at a second stage.
